(19) United States
(12) Patent Application Publication
(10) Pub. No.: US 2015/0007674 A1
(43) Pub. Date: Jan. 8, 2015

(54) ACTUATING DEVICE FOR ACTUATING A SHADING SYSTEM AND A SHADING SYSTEM WITH SUCH AN ACTUATING DEVICE

(71) Applicant: Hunter Douglas Industries Switzerland GmbH, Luzern (CH)

(72) Inventors: Wilfried GRAMSCH, Beverstedt (DE); Peter KLOSE, Bremervorde (DE); Guido TANTS, Midlum (DE)

(21) Appl. No.: 14/323,761

(22) Filed: Jul. 3, 2014

(30) Foreign Application Priority Data
Jul. 5, 2013 (DE) 10 2013 011 222.2

(51) Int. Cl. E06B 9/38; F16H 19/06

(52) U.S. Cl. CPC E06B 9/38; F16H 19/06
USPC 74/89.2

(57) ABSTRACT

An actuating device has a string element (16) for actuating a shading system (10), which string element is guided at least with one half loop (19) within an actuating device section (15) of the actuating device (11), with a gripping element (17) guided displaceably at the actuating device section in the longitudinal direction of the section. The gripping element has an actuating element (29, 30), which can be reached and operated with a thumb, for detachably connecting the gripping element with the string element. The actuating element is mounted pivotably at the gripping element. The actuating element has a mount (31) for receiving a section of the string element on a side facing the string element. The mount is U-shaped or C-shaped for partially enclosing the string element and/or for extending behind a string member (26) of the string element.

### CROSS REFERENCE TO RELATED APPLICATIONS

This application claims the benefit of priority under 35 U.S.C. §119 of German Patent Application DE 10 2013 011 222.2 filed Jul. 5, 2013, the entire contents of which are incorporated herein by reference.

### FIELD OF THE INVENTION

The present invention pertains to an actuating means or actuating device with a cord-like string element for actuating a shading system, which said element is guided at least with a half loop within a section of the actuating device, with a gripping element guided displaceably at the section in the longitudinal direction of the section, wherein the gripping element has at least one actuating element that can be reached and operated with a thumb, for detachably connecting the gripping element with the string element, and the at least one actuating element is mounted pivotably at the gripping element.

### BACKGROUND OF THE INVENTION

Such an actuating device is known from US 2011/0308745 A1.

An actuating device, in which a slide is provided, which can be displaced, as desired, into a first actuating position, a second actuating position and a released position between the two actuating positions, is known from DE 44 18 735 A1. The drawback here is that a complex mechanism is necessary for fixing the gripping element at the string element. In addition, the possibilities of arranging the actuating element are limited.

Furthermore, it should be borne in mind that there is a risk of undesired injury in case of a half loop of a string element hanging down freely. For example, the head of a person, especially a child, may be caught in the half loop and become strangled.

### SUMMARY OF THE INVENTION

A basic object of the present invention is therefore to further improve an actuating device of the type described in the introduction and/or a shading system with such an actuating device such that the design and/or mechanism is simplified, and the risk of injury, especially strangling, is avoided as much as possible. Furthermore, one object of the present invention is to increase the possibilities of arranging the actuating element, especially of two or more actuating elements.

The basic object of the present invention is accomplished by an actuating device of the type described in the introduction, in which the actuating element has a mount for receiving a section of the string element on a side facing the string element, wherein said mount is U-shaped or C-shaped for partially enclosing the string element and/or for extending behind a string member of the string element.

It is advantageous in this case that a simple and reliable actuating mechanism can be embodied based on the actuating element mounted pivotably about an axis. In particular, a plurality of actuating elements, preferably two actuating elements, can be arranged in different constellations in relation to one another at the gripping element. Two strings of the string elements can be prevented from being pulled apart from one another based on the section in which the string element is guided in a half loop. The risk of injury and/or strangling can be reliably prevented hereby. In particular, the string element is arranged and/or guided essentially and/or entirely within the section. The string element is preferably guided and/or arranged outside a drive and/or a guide rail of a shading system. In particular, the section can be arranged directly adjacent to a drive, a drive wheel and/or a guide rail.

A cord-like string element or a string element is preferably defined within the framework of the present invention as a cord, a chain, a belt, a cable, a filament, a line and/or a wire. A half loop is defined, in particular, as an essentially U-shaped and/or C-shaped arrangement of a cord-like string element within the framework of the present application. Two half loops of the same cord-like string element preferably form a loop and/or an endless loop.

According to a variant, the actuating element is mounted pivotably and/or rotatably about an axis arranged at the gripping element. The axis is directed, in particular, transversely, preferably at right angles to the longitudinal orientation of the string element and/or of the section. As a result, actuation of the actuating element with one hand, especially with a thumb, becomes possible in an ergonomically attractive manner when grasping around the string element and/or the gripping element.

According to another embodiment, the actuating element is pivoted in an actuating position about an axis in the direction of the string element. In particular, the actuating element is mounted rotatably on a housing and/or in a housing wall of the gripping element. The axis may be arranged in the housing and/or on a housing wall, especially on a front side, of the gripping element. The actuating element is preferably connected in the actuating position with the string element in a non-positive and/or positive-locking manner for moving the string element together with the gripping element in relation to the section. The actuating element is thus connected in the actuating position with the string element or the gripping element is fixed at the string element. The string element is movable as a result in the longitudinal direction of the section together with the gripping element.

The actuating element is preferably pivoted away from the string element about an axis in a released position. As a result, the gripping element is displaceable relative to the section and the string element in the longitudinal direction of the section. In particular, the actuating element can be automatically returned from the actuating position into the released position. A resetting element, especially a spring, which provides a resetting force in the actuating position, may be arranged in the area of the axis and/or of the mount for the pivotability of the actuating element. The actuating element is pivoted automatically into the released position based on the resetting force of the resetting element especially as soon as the actuating element is released in the actuating position. The gripping element may have a stop in order to limit the pivoting motion from the actuating position into the released position. In particular, the actuating element is arranged in the released position at the stop by means of the resetting element. The actuating element does not preferably mesh with the string element in the released position. The actuating element can be displaced relative to the string element together with the gripping element. As a result, the gripping element can be displaced from an end position at the end of the section to another position of the section without carrying along the string element. The string element is carried especially with the gripping element during a motion of the gripping element in a first direction of travel of the gripping element along the section. A second direction of travel of the gripping element that is opposite to and/or faces away from the first direction of travel is preferably provided for returning the gripping element without carrying along the string element.

In particular, the actuating element has a resetting element, especially for automatically returning the actuating element from the actuating position into the released position. The resetting element is preferably designed as a spring. The spring may be designed as a leaf spring. In particular, the spring may be associated with the mount and/or the axis of the actuating element. The actuating element is preferably arranged at one end of a feather rope. The axis, especially the virtual axis, about which the actuating element is pivotable, may thus be arranged in the area of the spring and/or feather rope. The actuating element may be made in one piece together with the gripping element, especially together with the resetting element. In particular, the actuating element and the gripping element can be manufactured, especially together with the resetting element, in an injection molding process as a single injection-molded part, preferably from plastic.

On a side facing the string element, the actuating element has a mount for receiving and/or partially extending around a section of the string element. The mount makes it possible, in particular, to establish a positive-locking connection, preferably in the actuating position, of the actuating element with the string element. The mounts may have a U-shaped or C-shaped design for partially enclosing the string element and/or for extending behind a string member of the string element. The string members are preferably connected permanently with the string element and/or are part of the string element itself. The string members may be formed from beads, flakes or disks. The string element may be designed as a bead chain. The string members are designed, in particular, as beads of a bead chain.

The mount preferably has a contact section for being in contact with the string element and/or with a string member of the string element. In particular, a positive-locking connection of the actuating element with the string element, especially a string member, can be established by means of the contact section. The mount may have a ramp section, which faces away from the contact section and extends in a ramp-like manner starting from the contact section and away from the string element. The actuating element can be pivoted away from the string element in the longitudinal direction of the section by means of the ramp section during a motion of the gripping element in a preset direction of travel, especially the second direction of travel.

The contact section and the ramp section may be arranged in one plane and/or on or along one axis, especially a virtual axis, which extends in parallel to the longitudinal orientation of a string section of the string element. The contact section and the ramp section are preferably arranged at two ends of the plane and/or of the axis that face away from one another.

According to another embodiment, the gripping element has a first actuating element and a second actuating element; in particular, the first actuating element and the second actuating element can be actuated independently from one another. One of the two actuating elements preferably remains in the released position when the respective other actuating element is in the actuating position. In particular, the actuating elements can be placed at the gripping element independently from one another. The first actuating element is preferably associated with a first string of the string element. The second actuating element may be associated with a second string of the string element.

A shading system is provided, preferably a blind, a vertical blind and/or a roller blind, especially advantageously with an actuating device according to the present invention. A drive for adjusting the shading system can be preferably driven by means of the actuating device. In particular, shading elements of the shading system can be moved together or moved apart. As an alternative or in addition, the shading elements can be rotated about their longitudinal axis. In particular, a roller blind is equipped with an actuating device according to the present invention. The roller blind may have a cord-like string element, especially a bead chain, for actuation by a human operator in order to bring about rolling up and/or rolling down of the roller blind.

Furthermore, the use of an actuating device according to the present invention and/or of a shading system according to the present invention for actuating a shading system and/or for driving a drive is advantageous. The risk of a person, especially a child, being injured by means of the string element, especially strangled, is considerably reduced or ruled out practically altogether in case of the actuating device according to the present invention and/or of a shading system with such an actuating device.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a perspective side view of a shading system with an actuating device according to the present invention;

FIG. 2 is a front view of an actuating device according to the present invention;

FIG. 3 is a detail view of a first cross section of the actuating device according to the present invention;

FIG. 4 is a detail view of another cross section of the actuating device according to the present invention;

FIG. 5 is a cross sectional view of a first section for an actuating device according to the present invention;

FIG. 6 is a cross sectional view of a second section for an actuating device according to the present invention; and

FIG. 7 is a cross sectional view of another section for an actuating device according to the present invention.

### DESCRIPTION OF THE PREFERRED EMBODIMENTS

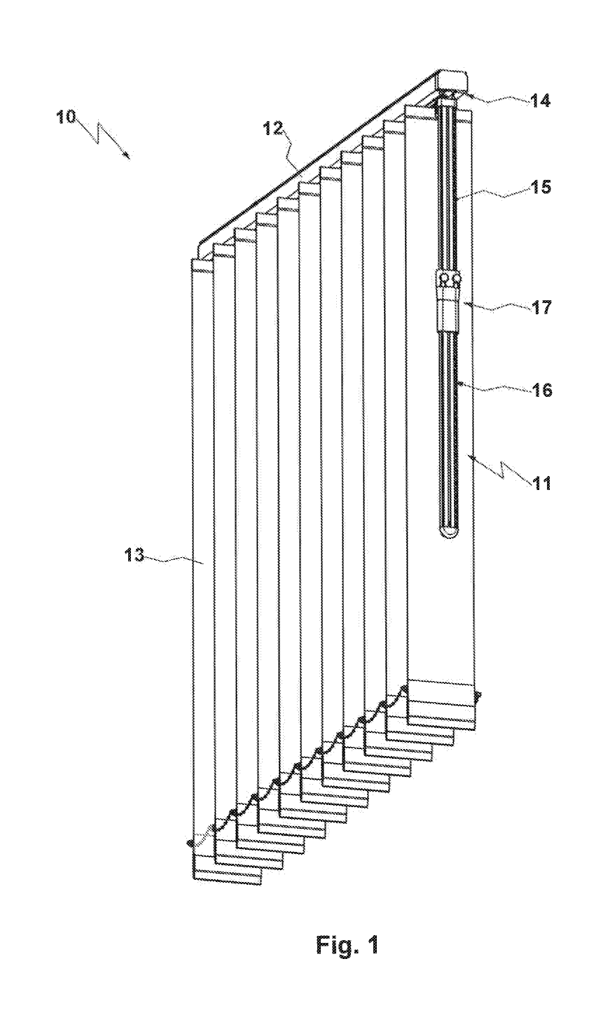

Referring to the drawings in particular, FIG. 1 shows a perspective side view of a shading system 10 with an actuating device 11 according to the present invention. The shading system 10 is designed as a vertical blind in this exemplary embodiment. The shading system 10 has a guide rail 12. The guide rail 12 can be mounted on a wall or ceiling via an opening of a building, which is not shown more specifically here. A plurality of shading elements 13 are guided movably in the guide rail 12. The shading elements 13, which are designed as slats here, hang down from the guide rail 12, which is directed essentially horizontally here.

A drive 14 is arranged at one end of the guide rail 12. The shading elements 13 can be moved with the drive 14. The shading elements 13 can be moved together and moved apart from one another along the guide rail 12 as well as rotated about their longitudinal axes here by means of the drive 14.

To drive the drive 14, the drive is connected with the actuating device 11. The actuating device 11 has a section 15. A cord-like string element 16 is guided and arranged within the section 15. Furthermore, the actuating element 11 has a gripping element 17, which is arranged at the section 15. The gripping element 17 is displaceable in the longitudinal direction of the section 15 for actuating the actuating device 11 and for moving the string element 16 within the section 15.

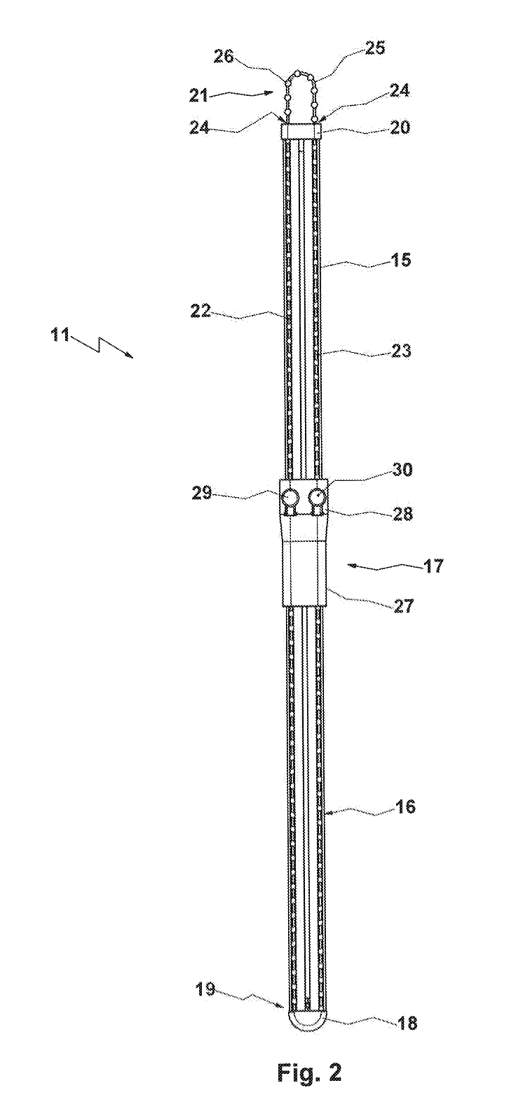

FIG. 2 shows a front view of an actuating device 11 according to the present invention. The section 16 has a deflecting element 18 at a first end. The string element 16 is led within the deflecting element 18 with a first half loop 19. The string element 16 is led in an essentially C-shaped or U-shaped pattern within the deflecting element 18. The section 15 has a lead-in element 20 at a second end of the section 15 facing away from the first end. The string element 16 exits the section 15 with a second half loop 21 in this exemplary embodiment. On its side facing the second half loop 21, the lead-in element 20 has openings, which have an outwardly opening or expanding funnel shape, not shown in more detail here.

The first half loop 19 and the second half loop 21 form a whole loop or an endless loop. Strings 22, 23 of the string element 16 extend now between the two half loops 19, 21 in parallel to one another. The string element 16 is arranged and guided entirely within the section 15. The string element 16 has a cord 25. String members 26 are fastened at equally spaced locations from one another on the cord 25 in this exemplary embodiment. As an alternative, the distances between string members 26 located directly adjacent to one another may differ from one another or vary. The string members 26 are designed, for example, as beads here. The string element 16 is thus designed as a bead chain in this exemplary embodiment.

The gripping element 17 arranged at the rigid and straight section 15 is held at the section 15 in a frictionally engaged manner in this exemplary embodiment in order to prevent the gripping element 17 from sliding automatically down along the section 15. The section 15 has, for example, a width of about 4 cm and a length of about 50 cm here.

The gripping element 17 encloses or grips around the outer circumference of the section 15 at right angles to the longitudinal orientation of the section 15. The gripping element 17 has a grip area 27 for grasping with one hand and an operating area 28 for actuating the gripping element 17 with one finger or thumb. The operating area 28 has a first actuating element 29 and a second actuating element 30. The actuating elements 29, 30 are designed as control buttons or control switches in this exemplary embodiment. The actuating elements 29, 30 are assigned here, for example, together to one side of the gripping element 17 and can be actuated independently from one another. The first actuating element 29 is associated with the string 22 and the second actuating element 30 with the string 23.

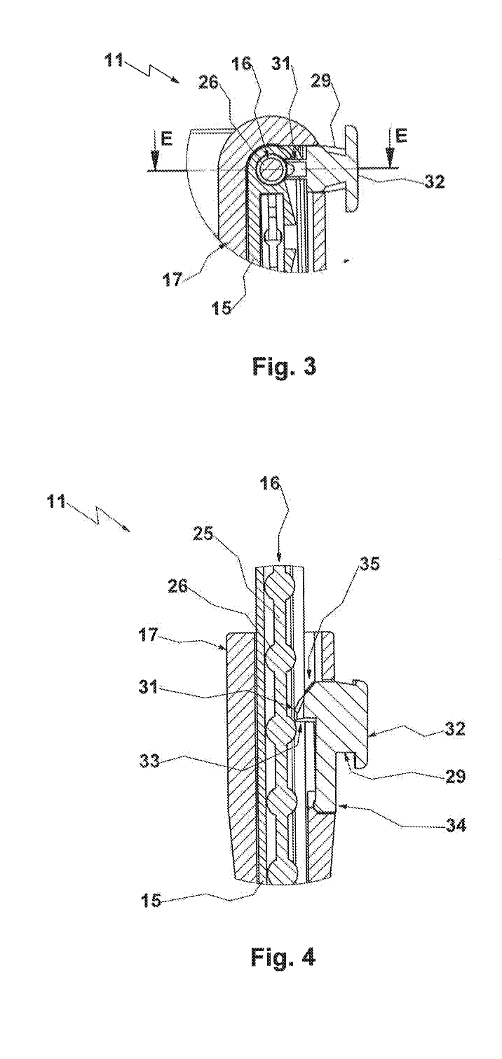

FIG. 3 shows a detail of a first cross section of the actuating device 11 according to the present invention. A cross section at right angles to the longitudinal orientation of the section 15 is shown specifically with a direction of view from the first half loop 19 in the direction of the second half loop 21.

The actuating element 29 has a U-shaped mount 31, which extends with its opening in the direction of the string element 16. The mount 31 is designed here such that the mount is suitable for partially grasping around or receiving a section of the cord 25, but the diameter of a string member 26 is greater than the internal diameter of the opening of the mount 31. The mount 31 is arranged within the gripping element 15 and faces the string element 16.

On a side facing away from the mount 31, the actuating element 29 or 30 has an operating surface 32. The operating surface 32 is provided for pressing the actuating element 29 into the gripping element 17 and in the direction of the string element 16. A cross section E-E is explained in more detail on the basis of the following FIG. 4.

FIG. 4 shows a detail of another cross section of the actuating device 11 according to the present invention, namely, the cross section E-E according to FIG. 3, which extends in the longitudinal direction of the section 15. The mount 31 has a contact section 33 for being brought into contact with the string element 16. The actuating element 29 is shown here in a released position, in which the gripping element 17 is displaceable in relation to the section 15 and the string element 16.

The actuating element 29 is pivoted about an axis 34 in the direction of the string element 16 in an actuating position not shown in more detail here. The contact section 33 extends here behind a string member 26 of the string element 16.

In a ramp section 35 facing away from the contact section 33, the mount 31 has a bezel, which extends in a ramp-like manner away from the string element 16. The contact section 33 and the ramp section 35 are arranged on a virtual axis in parallel to the string 22 and 23, respectively. The mount 31 is arranged essentially at an end of the actuating element 29 facing away from the axis 34.

All explanations related to the actuating element 29 also apply analogously to the actuating element 30 and vice versa.

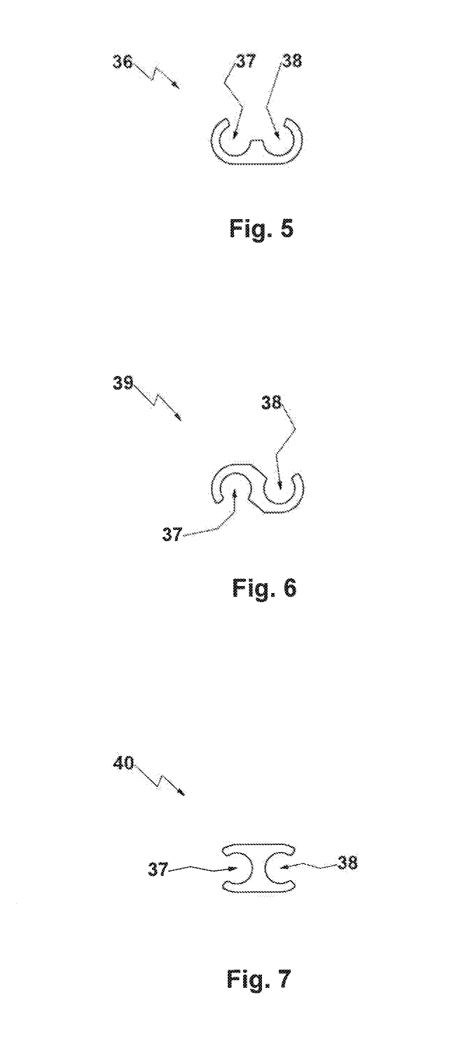

FIG. 5 shows a cross section of a first section 36 for an actuating device 11 according to the present invention. The section 36 has an essentially E-shaped or 3-shaped cross section. The section 36 has a first channel 37 and a second channel 38. The string element 16 can be arranged with its strings 22, 23 within the channels 37, 38. The actuating elements 29, 30 are arranged in the section 36 on the same side of the gripping element 17.

FIG. 6 shows a cross section of a second section 39 for an actuating device according to the present invention. The section 39 has an essentially S-shaped cross section, in which the first channel 37 and the second channel 38 are accessible from two sides that mutually face away from each other. The actuating elements 29 and 30 are thus arranged in the section 39 on two sides of a gripping element not shown in more detail here, which sides mutually face away from one another.

FIG. 7 shows a cross section of another section 40 for an actuating device according to the present invention. The section 40 has an essentially H-shaped cross section, in which the first channel 37 and the second channel 38 are accessible from two sides located such that they face away from each other. The actuating elements 29 and 30 are thus arranged in the section 39 on sides of a gripping element, not shown in more detail, which sides face away from each other.

The mode of operation of the present invention will be explained below on the basis of FIGS. 1 through 7:

To drive a drive 14 for adjusting shading elements 13 of a shading system 10, the gripping element 17 can be grasped by a user with one hand. The fingers and the inner surface of the hand can be placed around the grip area 27 such that the actuating elements 29, 30 can be reached and operated with a thumb.

Depending on the desired adjustment of the shading system, either the actuating element 29 or the actuating element 30 is operated as desired. The actuating element 29 or 30 is pivoted for this about the axis 34 in the direction of the string element 16 based on a pressure exerted on the operating surface 32. As a result, the mount 31 extends at least partly around a section of the cord 25.

If, for example, the actuating element 29 is actuated, the actuating element 29 comes into connection with a section of the string 22 of the string element 16. If, by contrast, the actuating element 30 is actuated, the actuating element 30 comes into connection with a section of the string 23 of the string element 16.

If the gripping element 17 is then pulled downward in the direction of the deflecting element 18 in the longitudinal direction of the section 15, the stop section 33 strikes a string member 26. The string element 16 is displaced hereby in the area of the string 22 together with the gripping element 17 relative to the section 16 in the direction of the deflecting element 18. The string element 16 is deflected in the form of the first half loop 19 in the area of the deflecting element 18, so that the string element 16 is moved in the area of the string 23 in the direction of the lead-in element 20. The string element 16 being moved exits the section 15 or the lead-in element 20 through a first opening 24 and is led around a drive wheel of the drive 14, which wheel is not shown in more detail here, in the form of the second half loop 21. The drive wheel or the drive 14 can be driven hereby. The string element 16 is then led again into the section 15 by means of a second funnel-shaped opening 24 of the lead-in element 20. The travel path of the gripping element 17 in the direction of the first half loop 19 is limited by the deflecting element 18.

The actuating element 30 is used corresponding to the explanations given above for actuating the string element 16 in the opposite direction.

To move the gripping element 17 again along the section in the direction of the lead-in element 20, the actuating element 29 or 30 is released and the gripping element 17 is displaced in the direction of the lead-in element 20 in relation to the section 15. The ramp section 35 thus comes into contact with a string member 16, and the actuating elements 29, 30 are pivoted away from the string element about the axis 34 based on the ramp-like design of the ramp section 35. The actuating elements 29, 30 and the mount 31 will cease to be in contact with the string element 16 as a result. The gripping element 17 is displaceable relative to the string element 16 in this released position.

Based on the essentially bar-like design of the actuating device 11 and the fact that the string element 16 is arranged and guided essentially entirely within the section 15, the risk of strangling with the actuating device 11 can be ruled out.

While specific embodiments of the invention have been shown and described in detail to illustrate the application of the principles of the invention, it will be understood that the invention may be embodied otherwise without departing from such principles.

What is claimed is:

1. An actuating device comprising:
an actuating device section;
a cord-like string element for actuating a shading system, the string element being guided at least with a half loop within the actuating device section;
a gripping element guided displaceably at the actuating device section in a longitudinal direction of the actuating device section, wherein:
the gripping element has at least one actuating element that can be reached and operated with a thumb for detachably connecting the gripping element with the string element;
the at least one actuating element is mounted pivotably at the gripping element;
the actuating element has a mount for receiving a section of the string element on a side facing the string element;
the mount is U-shaped or C-shaped for at least one of partially grasping around the string element and extending behind a string member of the string element.

2. An actuating device in accordance with claim 1, wherein:
the actuating element is mounted pivotably about an axis arranged at the gripping element; and
the axis is oriented at least one of transversely and at right angles to the longitudinal orientation of the string element and of the section.

3. An actuating device in accordance with claim 1, wherein:
the actuating element is pivoted in an actuating position about an axis in the direction of the string element; and
the actuating element is connected in the actuating position with the string element in at least one of a non-positive and a positive-locking manner for moving the string element together with the gripping element in relation to the actuating device section.

4. An actuating device in accordance with claim 1, wherein:
the actuating element is pivoted away from the string element about an axis in a released position;
the actuating element can be automatically returned from the actuating position into the released position; and
the actuating element does not mesh with the string element in the released position and/or the actuating element is displaceable together with the gripping element relative to the string element in the released position.

5. An actuating device in accordance with claim 1, wherein:
the actuating element has a resetting element for automatically returning the actuating element from the actuating position into the released position; and
the resetting element comprises a spring and/or the actuating element is arranged at one end of a feather rope.

6. An actuating device in accordance with claim 1, wherein the string member is a bead of a string element comprising a bead chain.

7. An actuating device in accordance with claim 6, wherein:
the mount has a contact section for being brought into contact with the string element and/or with a string member of the string element;
the mount preferably has a ramp section, which faces away from the contact section and extends away from the string element in a ramp-like manner starting from the contact section.

8. An actuating device in accordance with claim 7, wherein:
the contact section and the ramp section are arranged in one plane and/or along one axis, which extends in parallel to the longitudinal orientation of a string section of the string element; and
the contact section and the ramp section are arranged at two ends of the plane and/or of the axis that face away from one another.

9. An actuating device in accordance with claim 1, wherein:
the gripping element has a first actuating element and a second actuating element, which can be actuated independently from the first actuating element;
the first actuating element is associated with a first string of the string element and/or the second actuating element is associated with a second string of the string element.

10. A shading system, blind system, vertical blind system or roller blind system comprising:
an actuating device comprising:
an actuating device section;
a cord-like string element for actuating a shading system, the string element being guided at least with a half loop within the actuating device section;
a gripping element guided displaceably at the actuating device section in a longitudinal direction of the actuating device section, wherein:
the gripping element has at least one actuating element that can be reached and operated with a thumb for detachably connecting the gripping element with the string element;
the at least one actuating element is mounted pivotably at the gripping element;
the actuating element has a mount for receiving a section of the string element on a side facing the string element;
the mount is U-shaped or C-shaped for at least one of partially grasping around the string element and extending behind a string member of the string element; and
a drive driven by means of the actuating device for adjusting the shading system.

11. A system in accordance with claim 10, wherein:
the actuating element is mounted pivotably about an axis arranged at the gripping element; and
the axis is oriented at least one of transversely and at right angles to the longitudinal orientation of the string element and of the section.

12. A system in accordance with claim 10, wherein:
the actuating element is pivoted in an actuating position about an axis in the direction of the string element; and
the actuating element is connected in the actuating position with the string element in at least one of a non-positive and a positive-locking manner for moving the string element together with the gripping element in relation to the actuating device section.

13. A system in accordance with claim 10, wherein:
the actuating element is pivoted away from the string element about an axis in a released position;
the actuating element can be automatically returned from the actuating position into the released position; and
the actuating element does not mesh with the string element in the released position and/or the actuating element is displaceable together with the gripping element relative to the string element in the released position.

14. A system in accordance with claim 10, wherein:
the actuating element has a resetting element for automatically returning the actuating element from the actuating position into the released position; and
the resetting element comprises a spring and/or the actuating element is arranged at one end of a feather rope.

15. A system in accordance with claim 10, wherein the string member is a bead of a string element comprising a bead chain.

16. A system in accordance with claim 15, wherein:
the mount has a contact section for being brought into contact with the string element and/or with a string member of the string element;
the mount preferably has a ramp section, which faces away from the contact section and extends away from the string element in a ramp-like manner starting from the contact section.

17. A system in accordance with claim 16, wherein:
the contact section and the ramp section are arranged in one plane and/or along one axis, which extends in parallel to the longitudinal orientation of a string section of the string element; and
the contact section and the ramp section are arranged at two ends of the plane and/or of the axis that face away from one another.

18. A system in accordance with claim 10, wherein:
the gripping element has a first actuating element and a second actuating element, which can be actuated independently from the first actuating element;
the first actuating element is associated with a first string of the string element and/or the second actuating element is associated with a second string of the string element.

19. A method for actuating a shading system and/or for driving a drive, the method comprising the steps of:
providing an actuating device comprising:
an actuating device section;
a cord-like string element for actuating a shading system, the string element being guided at least with a half loop within the actuating device section;
a gripping element guided displaceably at the actuating device section in a longitudinal direction of the actuating device section, wherein:
the gripping element has at least one actuating element that can be reached and operated with a thumb for detachably connecting the gripping element with the string element;
the at least one actuating element is mounted pivotably at the gripping element;
the actuating element has a mount for receiving a section of the string element on a side facing the string element;
the mount is U-shaped or C-shaped for at least one of partially grasping around the string element and extending behind a string member of the string element; and
actuating a drive driven by means of the actuating device for adjusting the shading system or driving the drive.
